(19) United States
(12) Patent Application Publication
(10) Pub. No.: US 2025/0124269 A1
(43) Pub. Date: Apr. 17, 2025

(54) NEURON SYNAPSE BIFUNCTIONAL ELEMENT

(71) Applicant: ELECTRONICS AND TELECOMMUNICATIONS RESEARCH INSTITUTE, Daejeon (KR)

(72) Inventor: Jung Wook LIM, Daejeon (KR)

(73) Assignee: ELECTRONICS AND TELECOMMUNICATIONS RESEARCH INSTITUTE, Daejeon (KR)

(21) Appl. No.: 18/910,330

(22) Filed: Oct. 9, 2024

(30) Foreign Application Priority Data
Oct. 11, 2023 (KR) 10-2023-0135009
Aug. 13, 2024 (KR) 10-2024-0108322

(51) Int. Cl. G06N 3/063; G06N 3/08

(52) U.S. Cl. CPC G06N 3/063; G06N 3/08

(57) ABSTRACT

Disclosed is a neuron synapse bifunctional element, which includes a gate electrode, a charge supply layer provided on the gate electrode and formed of an oxide dielectric, a channel layer provided on the charge supply layer and formed of an oxide semiconductor, and a source electrode and a drain electrode provided on both sides of the channel layer, respectively, and as electrons or holes are trapped in a charge trapping layer between the channel layer and the charge supply layer, a magnitude and pattern of a current flow flowing in the channel layer change depending on a change in a signal applied to the gate electrode.

### CROSS-REFERENCE TO RELATED APPLICATIONS

This application claims priority under 35 U.S.C. § 119 to Korean Patent Application Nos. 10-2023-0135009 filed on Oct. 11, 2023, and 10-2024-0108322 filed on Aug. 13, 2024, in the Korean Intellectual Property Office, the disclosures of which are incorporated by reference herein in their entireties.

### BACKGROUND

Embodiments of the present disclosure described herein relate to a semiconductor device, and more particularly, relate to a bifunctional element capable of performing both a neuron function and a synapse function.

As research on artificial neural networks becomes more active, the demand for neuromorphic semiconductor devices that mimic the human brain and nerves is rapidly increasing. The human brain consumes little energy compared to performing complex calculations. Since the existing von Neumann method may consume a lot of energy, neuromorphic computing may perform superior calculations and inferences with low power by imitating a human brain structure.

This human brain structure allows synapses to remember a strength of spikes fired by neurons and performs a potentiation learning or a depression learning by assigning weights. Current neurons are implemented as complex circuits based on a CMOS device and implement Leaky-Integrate-Fire (LIF) characteristics using a membrane capacitor. In the case of synapse elements, research is continuing using devices based on an RRAM (resistive random access memory) or a memristor, but compatibility with existing CMOS devices is an issue.

### SUMMARY

Embodiments of the present disclosure provide an element that has excellent integration while satisfying CMOS compatibility.

According to an embodiment of the present disclosure, a neuron synapse bifunctional element includes a gate electrode, a charge supply layer provided on the gate electrode and formed of an oxide dielectric, a channel layer provided on the charge supply layer and formed of an oxide semiconductor, and a source electrode and a drain electrode provided on both sides of the channel layer, respectively, and as electrons or holes are trapped in a charge trapping layer between the channel layer and the charge supply layer, a magnitude and pattern of a current flow flowing in the channel layer change depending on a change in a signal applied to the gate electrode.

According to an embodiment, the neuron synapse bifunctional element may further include a learning direction determining dielectric having insulating properties between the charge supply layer and the gate electrode, the learning direction determining dielectric may be configured to control an intensity of an electric field distributed to the charge supply layer based on a thickness, a material type, and a density of a thin film, and the learning direction determining dielectric may be configured to perform a depression learning or a potentiation learning based on the intensity of the electric field.

According to an embodiment, the channel layer may include at least one of TiO₂, In₂O₃, SnO₂, ZnO, InTiO, SnTiO, ZnTiO, InSnO, ZnSnO, and InZnO.

According to an embodiment, when a trap having a first depth is formed in the charge trapping layer, the neuron synapse bifunctional element may be configured to perform a neuron element function having volatile characteristics.

According to an embodiment, when the charge trapping layer has a second depth deeper than the first depth, the neuron synapse bifunctional element may be configured to perform a synapse element function having non-volatile characteristics.

According to an embodiment, based on the intensity of the electric field distributed to the charge supply layer, when the electrons are trapped in the charge trapping layer, a threshold voltage value of the neuron synapse bifunctional element may increase to perform the depression learning, and based on the intensity of the electric field distributed to the charge supply layer, when the holes are trapped in the charge trapping layer, the threshold voltage value may decrease to perform the potentiation learning.

According to an embodiment, the channel layer may supply charges to the charge trapping layer, and the charge supply layer may supply the holes to the charge trapping layer.

According to an embodiment, the channel layer may be formed of an oxide semiconductor whose conductivity increases in response to light.

According to an embodiment of the present disclosure, a spike neural network circuit includes a synapse array including first neuron synapse bifunctional elements arranged in “n” rows and “m” columns, second neuron synapse bifunctional elements electrically connected corresponding to each of the “n” rows, and third neuron synapse bifunctional elements electrically connected corresponding to each of the “m” columns, and each of the first to third neuron synapse bifunctional elements includes a gate electrode, a charge supply layer provided on the gate electrode and formed of an oxide dielectric, a channel layer provided on the charge supply layer and formed of an oxide semiconductor, and a source electrode and a drain electrode provided on both sides of the channel layer, respectively, and as electrons or holes are trapped in a charge trapping layer between the channel layer and the charge supply layer, a magnitude and pattern of a current flow flowing in the channel layer change depending on a change in a signal applied to the gate electrode.

According to an embodiment, an external electrical stimulation may be applied to the gate electrodes of the first neuron synapse bifunctional elements, the channel layers of the first neuron synapse bifunctional elements may be connected to the gate electrodes of the second neuron synapse bifunctional elements, respectively, and the channel layers of the second neuron synapse bifunctional elements may be connected to the gate electrodes of the third neuron synapse bifunctional elements, respectively.

According to an embodiment, the spike neural network circuit may further include, when the external electrical stimulation is a current stimulation, a capacitor connected in parallel to the channel layer of the first neuron synapse bifunctional elements.

According to an embodiment, the spike neural network circuit may further include a learning direction determining dielectric having insulating properties between the charge supply layer and the gate electrode.

According to an embodiment, the channel layer may include at least one of TiO₂, In₂O₃, SnO₂, ZnO, InTiO, SnTiO, ZnTiO, InSnO, ZnSnO, and InZnO.

According to an embodiment, a depth of a trap formed in the charge trapping layer of the first neuron synapse bifunctional elements may be configured to be deeper than depths of traps formed in the charge trapping layers of the second neuron synapse bifunctional elements and the third neuron synapse bifunctional elements.

According to an embodiment, when the electrons are trapped in the charge trapping layer of the first neuron synapse bifunctional elements, a threshold voltage value may increase to perform the depression learning, and when the holes are trapped in the charge trapping layer of the first neuron synapse bifunctional elements, the threshold voltage value may decrease to perform the potentiation learning.

According to an embodiment, the channel layer may supply charges to the charge trapping layer, and the charge supply layer may supply the holes to the charge trapping layer.

According to an embodiment, the channel layer may be formed of an oxide semiconductor whose conductivity increases in response to light.

### BRIEF DESCRIPTION OF THE FIGURES

The above and other objects and features of the present disclosure will become apparent by describing in detail embodiments thereof with reference to the accompanying drawings.

FIG. 1 is a diagram illustrating a configuration of a neuron synapse bifunctional element, according to an embodiment of the present disclosure.

FIG. 2 is a diagram illustrating a change in current flowing through a channel layer when a neuron synapse bifunctional element performs a neuron element function or a synapse element function, according to an embodiment of the present disclosure.

FIGS. 3A to 3C are diagrams illustrating a change in current flowing through a channel layer depending on a signal applied to a gate electrode of a neuron synapse bifunctional element, according to an embodiment of the present disclosure.

FIG. 3A is a diagram illustrating a form of a signal of an electrical stimulation applied to a gate electrode.

FIG. 3B is a diagram illustrating a change in a threshold voltage and a change in current of a channel layer depending on a signal applied to a gate electrode.

FIG. 3C is a diagram illustrating a characteristic of a neuron synapse bifunctional element firing depending on a signal applied to a gate electrode when a neuron synapse bifunctional element performs a neuron element function.

FIG. 4 is a diagram illustrating a case where a neuron synapse bifunctional element generates voltage stimulation by a light stimulation, according to an embodiment of the present disclosure.

FIG. 5 is a diagram illustrating a neuron-synapse-neuron system, according to an embodiment of the present disclosure.

FIG. 6 is a drawing illustrating a detailed configuration of a neuron-synapse-neuron system when external electrical stimulation is a current stimulation, according to an embodiment of the present disclosure.

FIG. 7 is a drawing illustrating a detailed configuration of a neuron-synapse-neuron system when external electrical stimulation is a voltage stimulation, according to an embodiment of the present disclosure.

### DETAILED DESCRIPTION

The present disclosure is not limited to the embodiments disclosed below, but may be implemented in various forms and various modifications and changes may be applied. However, it is provided to complete the disclosure of the present disclosure through the description of the present embodiment, and to completely inform those skilled in the art of the scope of the disclosure to which the present disclosure belongs. In the accompanying drawings, for convenience of description, the size of the components is illustrated larger than the actual size, and the ratio of each component may be exaggerated or reduced.

In the specification, when one component is referred to as being on another component, it should be understood that the former may be directly on the latter, and also may be on the latter via a third intervening component. Also, in drawings, the thickness of components are exaggerated for effectiveness of description of technical contents. Throughout the specification, like reference numerals refer to like components.

Although terms such as first, second, and third are used to describe various components in various embodiments of the present specification, these components should not be limited by these terms. These terms are only used to distinguish one component from another component. Embodiments described and illustrated herein also include complementary embodiments thereof.

The terms used herein are provided to describe the embodiments but not to limit the present disclosure. In addition, unless otherwise defined, terms used in the embodiments of the present disclosure may be interpreted as meanings commonly known to those skilled in the art.

In the specification, the singular forms include plural forms unless particularly mentioned. As used herein, “comprises and/or comprising” does not exclude the presence or addition of one or more other components, steps, operations and/or elements to the mentioned components, steps, operations and/or elements.

Hereinafter, embodiments of the present disclosure may be described in detail and clearly to such an extent that an ordinary one in the art easily implements the present disclosure.

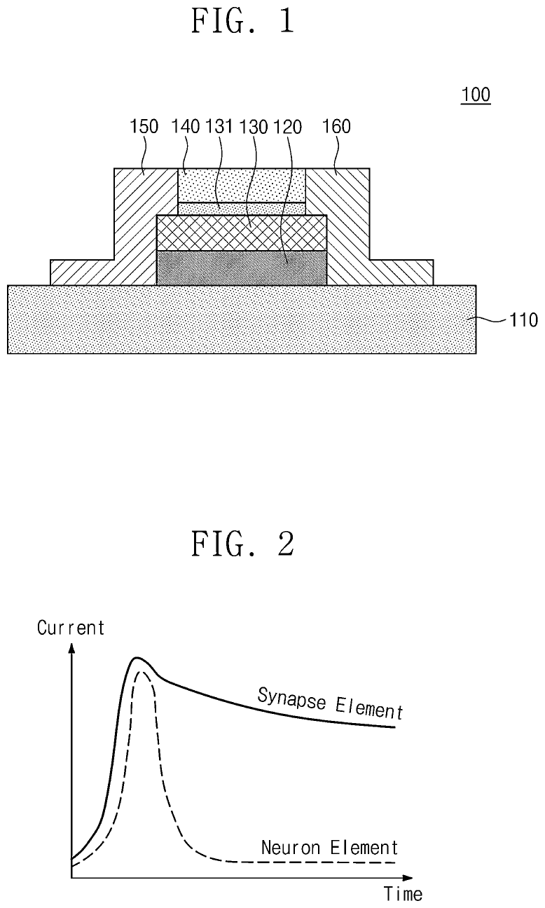

FIG. 1 is a diagram illustrating a configuration of a neuron synapse bifunctional element 100, according to an embodiment of the present disclosure.

Referring to FIG. 1, the neuron synapse bifunctional element 100 may include a gate electrode 110, a learning direction determining dielectric 120, a charge supply layer 130, a charge trapping layer 131, a channel layer 140, a source electrode 150, and a drain electrode 160. For example, the neuron synapse bifunctional element 100 may be configured in a form compatible with a MOSFET device. For example, in this specification, the neuron synapse bifunctional element 100 will be described through an example formed with a bottom gate structure, but the neuron synapse bifunctional element 100 may also be implemented as a neuron synapse bifunctional element with a top gate structure having the same technical characteristics.

The gate electrode 110 may have a plate shape that extends along a plane defined by a first direction and a second direction. The first direction and the second direction may intersect each other. For example, the first direction and the second direction may be horizontal directions that are orthogonal to each other.

The gate electrode 110 may include a conductive material. For example, the gate electrode 110 may include a plurality of metal layers. For example, the gate electrode 110 may include at least one of Ni, Ti, Pt, or Au. For example, the gate electrode 110 may include high-concentration doped silicon, TiN, etc.

The learning direction determining dielectric 120 may be provided on the gate electrode 110. The learning direction determining dielectric 120 may contact an upper surface of the gate electrode 110.

The learning direction determining dielectric 120 may be configured to increase a breakdown voltage of the neuron synapse bifunctional element 100 and to improve durability. The learning direction determining dielectric 120 may include an insulating material having insulating properties. For example, the learning direction determining dielectric 120 may include a high-k dielectric material. For example, the learning direction determining dielectric 120 may include an oxide dielectric. For example, the learning direction determining dielectric 120 may include Al₂O₃, TiOₓ, HfOₓ, or SiOₓ.

When the neuron synapse bifunctional element 100 performs a synapse element function, the neuron synapse bifunctional element 100 may be configured to perform potentiation learning or depression learning depending on the characteristics of the learning direction determining dielectric 120. For example, the learning direction determining dielectric 120 may be configured to control intensity of the electric field distributed to the charge supply layer 130 based on a thickness of a thin film that forms the learning direction determining dielectric 120, a type of material of the thin film, and a density of the thin film. For example, as the thickness of the thin film of the learning direction determining dielectric 120 becomes thinner, the neuron synapse bifunctional element 100 may be configured to perform the potentiation learning. For example, as the dielectric constant increases due to the type of material and the density of the thin film of the learning direction determining dielectric 120, the neuron synapse bifunctional element 100 may be configured to perform the potentiation learning. The charge supply layer 130 may be provided on the learning direction determining dielectric 120. The charge supply layer 130 may be in contact with an upper surface of the learning direction determining dielectric 120.

The charge supply layer 130 may be composed of an oxide dielectric.

For example, the charge supply layer 130 may include a relatively low-k material compared to the learning direction determining dielectric 120 or a non-stoichiometric oxide, etc. For example, the charge supply layer 130 may include SiOₓ, AlOₓ, ZnOₓ, HfOₓ, NiOₓ, CuO, Fe₂O₃, etc.

The charge trapping layer 131 may be formed on the charge supply layer 130, and the channel layer 140 may be provided on the charge trapping layer 131. The channel layer 140 may be in contact with an upper surface of the charge trapping layer 131.

The channel layer 140 may be composed of an oxide semiconductor. For example, the channel layer 140 may be composed of an oxide semiconductor capable of detecting light. For example, the oxide semiconductor capable of detecting light may generate pairs of electrons and holes by light. For example, when pairs of electrons and holes are generated in an oxide semiconductor, the conductivity of the channel layer 140 may increase. For example, the channel layer 140 may include TiO₂, In₂O₃, SnO₂, ZnO, InTiO, SnTiO, ZnTiO, InSnO, ZnSnO, or InZnO.

The source electrode 150 and the drain electrode 160 may be provided on both sides of the channel layer 140, respectively. The source electrode 150 and the drain electrode 160 may be electrically connected to the channel layer 140.

Electrons or holes may be trapped in the charge trapping layer 131 between the charge supply layer 130 and the channel layer 140. For example, the charge supply layer 130 may be configured to provide holes to the charge trapping layer 131 through oxygen excess according to an electric field applied to the gate electrode 110. For example, when a positive voltage is applied to the gate electrode 110, the charge supply layer 130 may be configured to provide holes to the charge trapping layer 131. For example, when the charge supply layer 130 provides holes to the charge trapping layer 131, the holes may be trapped in the charge trapping layer 131. For example, the thickness of the charge trapping layer 131 may be formed to be 0.5 nm to 5 nm or less. For example, the channel layer 140 may be configured to provide electrons to the charge trapping layer 131 through oxygen deficiency according to the electric field applied to the gate electrode 110. For example, when a negative voltage is applied to the gate electrode 110, the channel layer 140 may be configured to provide electrons to the charge trapping layer 131. For example, even when a positive voltage is applied to the gate electrode 110, the channel layer 140 may be configured to provide electrons to the charge trapping layer 131 according to the pulse amplitude of the positive voltage. For example, as the pulse amplitude of the positive voltage decreases, the channel layer 140 may be configured to provide more electrons to the charge trapping layer 131. For example, when the channel layer 140 provides electrons to the charge trapping layer 131, electrons may be trapped in the charge trapping layer 131.

The neuron synapse bifunctional element 100 may be configured to perform a neuron element function with volatile characteristics or a synapse element function with nonvolatile characteristics using the same type of element. For example, when a deep trap is formed in the charge trapping layer 131, electrons or holes may be trapped in the charge trapping layer 131 for a longer period of time than when a shallow trap is formed in the charge trapping layer 131. For example, in the case of electrons, the depth of the trap may be the depth from the conduction band of the charge trapping layer 131. For example, the neuron synapse bifunctional element 100 may be configured to have nonvolatile characteristics or volatile characteristics based on the time that electrons or holes are trapped in the charge trapping layer 131. For example, when a deep trap is formed in the charge trapping layer 131, the neuron synapse bifunctional element 100 may be configured to perform a synapse element function having nonvolatile characteristics. For example, when a shallow trap is formed in the charge trapping layer 131, the neuron synapse bifunctional element 100 may be configured to perform a neuron element function having volatile characteristics. For example, when a trap of a first depth is formed in the charge trapping layer 131, the neuron synapse bifunctional element 100 may be configured to perform a neuron element function. For example, when a trap of a second depth is formed in the charge trapping layer 131, the neuron synapse bifunctional element 100 may be configured to perform a synapse element function. For example, the trap of the second depth may be deeper than the trap of the first depth.

As the characteristics or structure of each component of the neuron synapse bifunctional element 100 change, a deep trap or a shallow trap may be formed in the charge trapping layer 131. For example, the depth of the trap of the charge trapping layer 131 may change depending on the thickness and structure of the learning direction determining dielectric 120 and the thickness and structure of the channel layer 140. For example, the depth of the trap of the charge trapping layer 131 may change depending on the dielectric constant of the dielectric material included in the charge supply layer 130. For example, as the dielectric constant of the dielectric material included in the charge supply layer 130 increases, the depth of the trap of the charge trapping layer 131 may become deeper. For example, the depth of the trap of the charge trapping layer 131 may change depending on the degree of hydrogen passivation performed on the charge trapping layer 131 during the semiconductor process.

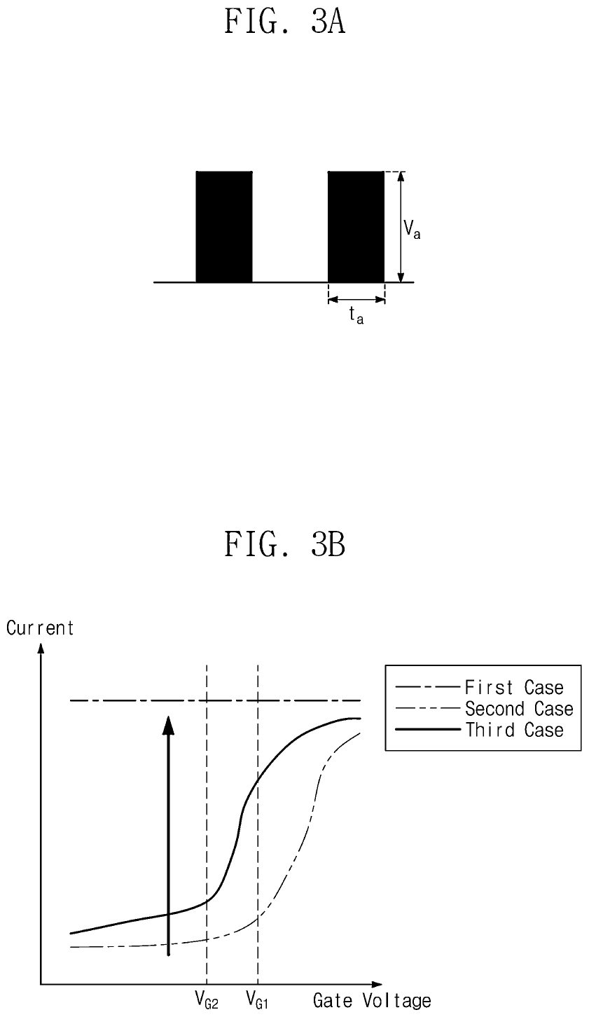

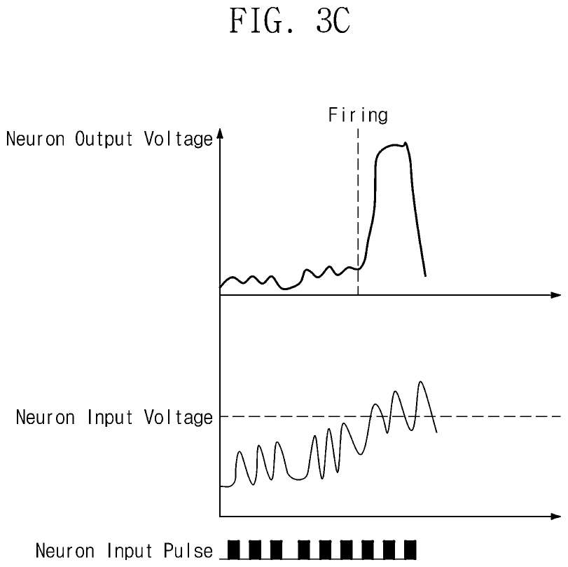

A detail description of how the neuron synapse bifunctional element 100 performs the neuron element function and the synapse element function will be described later with reference to FIGS. 2 to 3C.

For example, when electrons are trapped in the charge trapping layer 131, a threshold voltage of the neuron synapse bifunctional element 100 may increase. When holes are trapped in the charge trapping layer 131, the threshold voltage of the neuron synapse bifunctional element 100 may decrease.

When the neuron synapse bifunctional element 100 performs the synapse element function, the neuron synapse bifunctional element 100 may perform depression learning or potentiation learning based on that electrons or holes are trapped in the charge trapping layer 131. For example, when electrons are trapped in the charge trapping layer 131, the threshold voltage increases, so that the neuron synapse bifunctional element 100 may perform depression learning. For example, when holes are trapped in the charge trapping layer 131, the threshold voltage decreases, so that the neuron synapse bifunctional element 100 may perform potentiation learning. For example, when depression learning is performed, the magnitude of the current flowing through the channel layer 140 of the neuron synapse bifunctional element 100 may decrease. For example, when potentiation learning is performed, the magnitude of the current flowing through the channel layer 140 of the neuron synapse bifunctional element 100 may increase.

According to an embodiment of the present disclosure, an element is provided that may perform the function of a synapse element or a neuron element depending on the depth of a trap formed in a charge trapping layer between a charge supply layer and a channel layer using a non-silicon oxide semiconductor and an oxide dielectric.

By the above configuration, the functions of a neuron and a synapse may be performed as a single element with the same type of element, thereby increasing the circuit integration while maintaining compatibility with existing CMOS devices. In addition, by using an oxide semiconductor capable of detecting light, the functions of a neuron and a synapse may be implemented not only for electrical stimulation but also for light stimulation.

FIG. 2 is a diagram illustrating a change in current flowing through a channel layer when a neuron synapse bifunctional element performs a neuron element function or a synapse element function, according to an embodiment of the present disclosure. Hereinafter, a description will be given with reference to FIG. 1 together.

Referring to FIG. 2, an x-axis represents a time and a y-axis represents a magnitude of a current. A graph of FIG. 2, in the case of the neuron element, represents a characteristic in which the current rapidly increases at a specific time and then decreases immediately. The case of the synapse element represents a characteristic in which the current rapidly increases at a specific time, but the increased current is continuously maintained.

When the neuron synapse bifunctional element 100 performs the neuron element function, the time trapped in the charge trapping layer 131 may be shorter since the charge trapping layer 131 has a shallower trap than when performing the synapse element function. For example, as a shallow trap is formed in the charge trapping layer 131, the neuron synapse bifunctional element 100 may have volatile characteristics in which electrons or holes trapped in the charge trapping layer 131 are attenuated. For example, the neuron synapse bifunctional element 100 may have a firing characteristic in which the current rapidly increases at a specific voltage according to an accumulation of a signal applied to the gate electrode 110. For example, as a shallow trap is formed in the charge trapping layer 131, the neuron synapse bifunctional element 100 may have a leaky-integrate-fire (LIF) characteristic in which electrons or holes are attenuated, accumulated, and fired in the charge trapping layer 131. For example, as the neuron synapse bifunctional element 100 has the leaky-integrate-fire characteristic, the neuron synapse bifunctional element 100 may be configured to perform a neuron element function having a volatile characteristic.

When the neuron synapse bifunctional element 100 performs a synapse element function, the time trapped in the charge trapping layer 131 may be longer by controlling the charge trapping layer 131 to have a deeper trap than when performing the neuron element function. For example, as a deep trap is formed in the charge trapping layer 131, electrons or holes trapped in the charge trapping layer 131 may have an accumulative non-volatile characteristic. For example, depending on the degree to which electrons or holes trapped in the charge trapping layer 131 are accumulated, a weight may be assigned to the signal applied to the gate electrode 110. For example, depending on the degree to which electron traps are accumulated in the charge trapping layer 131, the threshold voltage may increase, so that the neuron synapse bifunctional element 100 may perform depression learning. For example, when the degree to which the electrons are trapped increases, the magnitude of the current flowing through the channel layer 140 of the neuron synapse bifunctional element 100 may decrease. For example, depending on the degree to which hole traps are accumulated in the charge trapping layer 131, the threshold voltage may decrease, so that the neuron synapse bifunctional element 100 may perform potentiation learning. For example, when the degree to which the holes are trapped increases, the magnitude of the current flowing through the channel layer 140 of the neuron synapse bifunctional element 100 may increase. For example, since the neuron synapse bifunctional element 100 has a characteristic in which traps of electrons or holes are accumulated and weighted, the neuron synapse bifunctional element 100 may be configured to perform a synapse element function having a nonvolatile characteristic.

FIGS. 3A to 3C are diagrams illustrating a change in current flowing through a channel layer depending on a signal applied to a gate electrode of a neuron synapse bifunctional element, according to an embodiment of the present disclosure. FIG. 3A is a diagram illustrating a form of a signal of an electrical stimulation applied to a gate electrode. FIG. 3B is a diagram illustrating a change in a threshold voltage and a change in current of a channel layer depending on a signal applied to a gate electrode. FIG. 3C is a diagram illustrating a characteristic of a neuron synapse bifunctional element firing depending on a signal applied to a gate electrode when a neuron synapse bifunctional element performs a neuron element function. Hereinafter, a description will be given with reference to FIG. 1 together.

Referring to FIG. 3A, an x-axis represents a time and a y-axis represents a magnitude of a voltage. A form of the external signal applied to the gate electrode 110 of the neuron synapse bifunctional element 100 may be a pulse form, as illustrated in FIG. 3A. For example, depending on a time “ta” and voltage magnitude “Va” of the pulse applied to the gate electrode 110, the current flowing through the channel layer 140 may change. For example, the external signal may include not only an electrical signal but also a light stimulation. For example, even if the external signal is a light stimulation, the form of a pulse may appear as illustrated in FIG. 3A.

Referring to FIG. 3B, as the voltage magnitude of the gate electrode 110 increases, the current flowing through the channel layer 140 may increase.

A first case represents the magnitude of the current flowing through the channel layer 140 when the magnitude “Va” of the pulse voltage applied to the gate electrode 110 is greater than or equal to the threshold voltage. For example, when the magnitude “Va” of the pulse voltage is greater than or equal to the threshold voltage, a high and uniform current may flow through the channel layer 140 regardless of the voltage of the gate electrode 110.

Second and third cases represent the magnitude of the current flowing through the channel layer 140 when the magnitude “Va” of the pulse voltage is less than or equal to the threshold voltage. For example, as the pulse voltage is applied, holes may be trapped in the charge trapping layer 131, thereby decreasing the threshold voltage. For example, the current graph of the channel layer 140 versus the voltage of the gate electrode 110 may move in the negative direction as the pulse voltage is applied. For example, the current graph of the channel layer 140 versus the voltage of the gate electrode 110 may move from the second case to the third case as the pulse voltage is applied.

In the current graph of the channel layer 140 versus the voltage of the gate electrode 110, the second case may have a first threshold voltage VG1 and the third case may have a second threshold voltage VG2. For example, referring to the second case and the third case, the threshold voltage may decrease as the pulse voltage is applied. For example, the second threshold voltage VG2 may be less than the first threshold voltage VG1. For example, as the pulse voltage is applied, the current flowing through the channel layer 140 may increase. As described in FIG. 2, the increased current may decrease over time.

Referring to FIG. 3C, when a shallow trap is formed in the charge trapping layer 131, as a pulse voltage is applied to the gate electrode 110, a Leaky-Integrate-Fire (LIF) characteristic may be exhibited. For example, a pulse voltage having a uniform pulse voltage magnitude “Va” may be continuously applied from the outside to the gate electrode 110. For example, a process in which holes are trapped and accumulated in the charge trapping layer 131 by the time “ta” during which the pulse voltage is applied, and holes trapped in the charge trapping layer 131 are attenuated during a time when the pulse voltage is not applied may be repeated. For example, as the pulse voltage applied to the gate electrode 110 is accumulated, a firing characteristic in which the output voltage rapidly increases at a specific voltage may be exhibited.

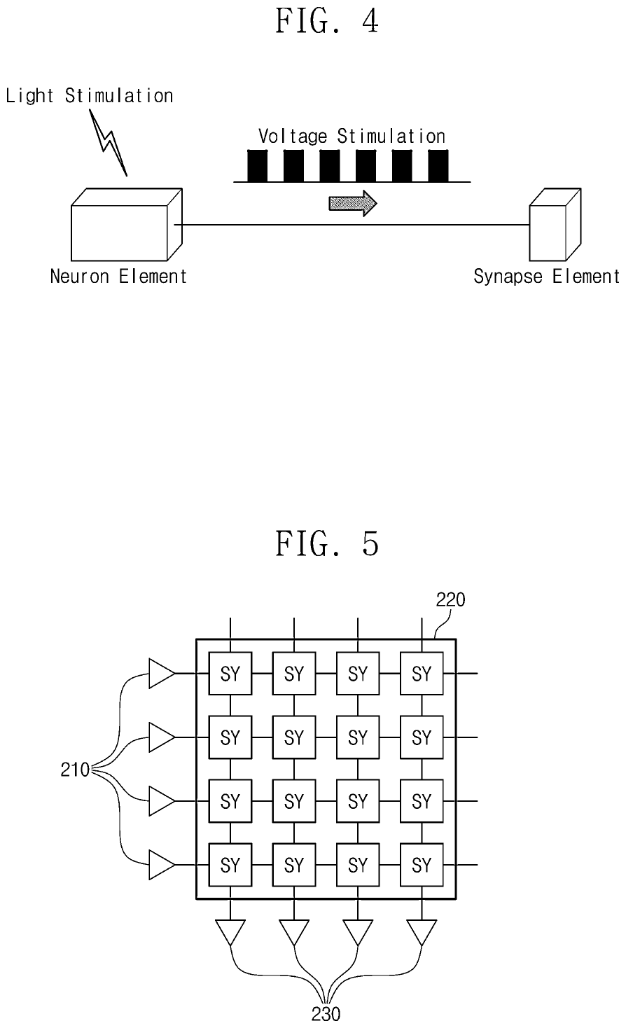

FIG. 4 is a diagram illustrating a case where a neuron synapse bifunctional element generates voltage stimulation by a light stimulation, according to an embodiment of the present disclosure.

Referring to FIG. 1 together, the channel layer 140 of the neuron synapse bifunctional element 100 may be composed of an oxide semiconductor capable of detecting light. For example, when a light stimulation is provided to the neuron synapse bifunctional element 100 performing a neuron element function, pairs of electrons and holes may be generated in the channel layer 140. As described above, the neuron synapse bifunctional element 100 may fire above a specific voltage to generate an output voltage stimulation. As another example, when a light stimulation is provided to the neuron synapse bifunctional element 100 performing a synapse element function, the neuron synapse bifunctional element 100 may perform potentiation learning or depression learning on the output voltage stimulation, based on that traps of electrons or holes are accumulated and weighted.

FIG. 5 is a diagram illustrating a neuron-synapse-neuron system, according to an embodiment of the present disclosure.

A neuron-synapse-neuron system may include a pre-neuron set, a synapse array, and a post-neuron set. The pre-neuron set may include first neuron synapse bifunctional elements 210. The synapse array may include second neuron synapse bifunctional elements 220. The post-neuron set may include third neuron synapse bifunctional elements 230. As described in FIG. 1, the first to third neuron synapse bifunctional elements 210 to 230 may perform the same function as the neuron synapse bifunctional element of FIG. 1.

The second neuron synapse bifunctional elements 220 may be configured to perform a synapse element function. The first neuron synapse bifunctional elements 210 and the third neuron synapse bifunctional elements 230 may be configured to perform a neuron element function. For example, the depth of the trap formed in the charge trapping layer of the second neuron synapse bifunctional elements 220 may be configured to be deeper than the depth of the traps formed in the charge trapping layers of the first neuron synapse bifunctional elements 210 and the third neuron synapse bifunctional elements 230.

In a neuron-synapse-neuron system, multiple synapse elements may be connected to one neuron element. For example, the second neuron synapse bifunctional elements 220 may be arranged in “n” rows and “m” columns (where, “n” and “m” are natural numbers). For example, the first neuron synapse bifunctional elements 210 may be electrically connected to each of the “n” rows of the second neuron synapse bifunctional elements 220. For example, the third neuron synapse bifunctional elements 230 may be electrically connected to each of the “m” columns of the second neuron synapse bifunctional elements 220.

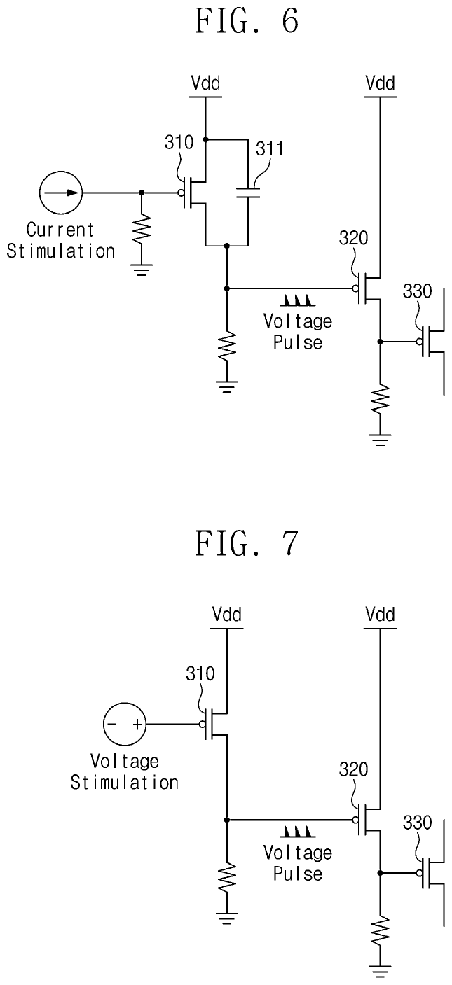

FIG. 6 is a drawing illustrating a detailed configuration of a neuron-synapse-neuron system when external electrical stimulation is a current stimulation, according to an embodiment of the present disclosure. FIG. 7 is a drawing illustrating a detailed configuration of a neuron-synapse-neuron system when external electrical stimulation is a voltage stimulation, according to an embodiment of the present disclosure. Hereinafter, a description will be given with reference to FIG. 1 and FIG. 5 together.

Referring to FIG. 6 and FIG. 7, a pre-neuron element 310, a synapse element 320, and a post-neuron element 330 may be electrically connected. For convenience of description, FIG. 6 and FIG. 7 illustrate a case where one synapse element 320 is connected to the pre-neuron element 310 and the post-neuron element 330, but as described in FIG. 5, the pre-neuron element 310 and the post-neuron element 330 may be connected to multiple synapse elements. For example, the first neuron synapse bifunctional elements 210 may include the pre-neuron element 310, the second neuron synapse bifunctional elements 220 may include the synapse element 320, and the third neuron synapse bifunctional elements 230 may include the post-neuron element 330.

Referring to FIGS. 6 and 7, an external electrical stimulation may be applied to the gate electrode of the pre-neuron element 310. For example, the external electrical stimulation may refer to an electrical stimulation generated from a previous synapse element. The channel layer of the pre-neuron element 310 may be connected to a gate electrode of the synapse element 320, and the channel layer of the synapse element 320 may be connected to a gate electrode of the post-neuron element 330.

Referring to FIG. 6, the external electrical stimulation may be a current stimulation. When the external electrical stimulation is a current stimulation, a capacitor 311 may be connected in parallel to the channel layer of the pre-neuron element 310.

The capacitor 311 may accumulate charges based on the external current stimulation. For example, charges may be accumulated in the capacitor 311 based on a signal applied to the gate electrode of the pre-neuron element 310. For example, even if a voltage of the gate electrode of the pre-neuron element 310 is below the threshold voltage, the pre-neuron element 310 may be fired as charges are accumulated in the capacitor 311. However, even if the external electrical stimulation is a current stimulation, the capacitor 311 is not necessarily required to be provided in the neuron-synapse-neuron system, and the pre-neuron element 310 may be fired as electrons or holes accumulate in the charge trapping layer of the pre-neuron element 310.

Referring to FIG. 7, the external electrical stimulation may be a voltage stimulation. When the external electrical stimulation is a voltage stimulation, in the neuron-synapse-neuron system, unlike FIG. 6, the capacitor may not be connected to the channel layer of the pre-neuron element 310.

According to an embodiment of the present disclosure, an element is provided that may perform the function of a synapse element or a neuron element depending on the depth of a trap formed in a charge trapping layer between a charge supply layer and a channel layer using a non-silicon oxide semiconductor and an oxide dielectric.

By the above configuration, the functions of a neuron and a synapse may be performed as a single element with the same type of element, thereby increasing the circuit integration while maintaining compatibility with existing CMOS devices. In addition, by using an oxide semiconductor capable of detecting light, the functions of a neuron and a synapse may be implemented not only for electrical stimulation but also for light stimulation.

The above descriptions are detail embodiments for carrying out the present disclosure. Embodiments in which a design is changed simply or which are easily changed may be included in the present disclosure as well as an embodiment described above. In addition, technologies that are easily changed and implemented by using the above embodiments may be included in the present disclosure. Therefore, the scope of the present disclosure should not be limited to the above-described embodiments and should be defined by not only the claims to be described later, but also those equivalent to the claims of the present disclosure.

What is claimed is:

1. A neuron synapse bifunctional element comprising:
a gate electrode;
a charge supply layer provided on the gate electrode and formed of an oxide dielectric;
a channel layer provided on the charge supply layer and formed of an oxide semiconductor; and
a source electrode and a drain electrode provided on both sides of the channel layer, respectively, and
wherein as electrons or holes are trapped in a charge trapping layer between the channel layer and the charge supply layer, a magnitude and pattern of a current flow flowing in the channel layer change depending on a change in a signal applied to the gate electrode.

2. The neuron synapse bifunctional element of claim 1, further comprising:
a learning direction determining dielectric having insulating properties between the charge supply layer and the gate electrode, and
wherein the learning direction determining dielectric is configured to control an intensity of an electric field distributed to the charge supply layer based on a thickness, a material type, and a density of a thin film, and
wherein the learning direction determining dielectric is configured to perform a depression learning or a potentiation learning based on the intensity of the electric field.

3. The neuron synapse bifunctional element of claim 2, wherein the channel layer includes at least one of TiO₂, In₂O₃, SnO₂, ZnO, InTiO, SnTiO, ZnTiO, InSnO, ZnSnO, and InZnO.

4. The neuron synapse bifunctional element of claim 2, wherein, when a trap having a first depth is formed in the charge trapping layer, the neuron synapse bifunctional element is configured to perform a neuron element function having volatile characteristics.

5. The neuron synapse bifunctional element of claim 4, wherein, when the charge trapping layer has a second depth deeper than the first depth, the neuron synapse bifunctional element is configured to perform a synapse element function having non-volatile characteristics.

6. The neuron synapse bifunctional element of claim 2, wherein, based on the intensity of the electric field distributed to the charge supply layer, when the electrons are trapped in the charge trapping layer, a threshold voltage value of the neuron synapse bifunctional element increases to perform the depression learning, and
wherein based on the intensity of the electric field distributed to the charge supply layer, when the holes are trapped in the charge trapping layer, the threshold voltage value decreases to perform the potentiation learning.

7. The neuron synapse bifunctional element of claim 2, wherein the channel layer is configured to supply the electrons to the charge trapping layer, and
wherein the charge supply layer is configured to supply the holes to the charge trapping layer.

8. The neuron synapse bifunctional element of claim 2, wherein the channel layer is formed of an oxide semiconductor whose conductivity increases in response to light.

9. A spike neural network circuit comprising:
a synapse array including first neuron synapse bifunctional elements arranged in “n” rows and “m” columns;
second neuron synapse bifunctional elements electrically connected corresponding to each of the “n” rows; and
third neuron synapse bifunctional elements electrically connected corresponding to each of the “m” columns, and
wherein each of the first to third neuron synapse bifunctional elements includes:
a gate electrode;
a charge supply layer provided on the gate electrode and formed of an oxide dielectric;
a channel layer provided on the charge supply layer and formed of an oxide semiconductor; and
a source electrode and a drain electrode provided on both sides of the channel layer, respectively, and
wherein as electrons or holes are trapped in a charge trapping layer between the channel layer and the charge supply layer, a magnitude and pattern of a current flow flowing in the channel layer change depending on a change in a signal applied to the gate electrode.

10. The spike neural network circuit of claim 9, wherein an external electrical stimulation is applied to the gate electrodes of the second neuron synapse bifunctional elements,
wherein the channel layers of the second neuron synapse bifunctional elements are connected to the gate electrodes of the first neuron synapse bifunctional elements, respectively, and
wherein the channel layers of the first neuron synapse bifunctional elements are connected to the gate electrodes of the third neuron synapse bifunctional elements, respectively.

11. The spike neural network circuit of claim 10, further comprising:
when the external electrical stimulation is a current stimulation, capacitors connected in parallel to each of the channel layer of the second neuron synapse bifunctional elements.

12. The spike neural network circuit of claim 9, further comprising:
a learning direction determining dielectric having insulating properties between the charge supply layer and the gate electrode, and
wherein the learning direction determining dielectric is configured to control an intensity of an electric field distributed to the charge supply layer based on a thickness, a material type, and a density of a thin film, and
wherein the learning direction determining dielectric is configured to perform a depression learning or a potentiation learning based on the intensity of the electric field.

13. The spike neural network circuit of claim 9, wherein the channel layer includes at least one of TiO₂, In₂O₃, SnO₂, ZnO, InTiO, SnTiO, ZnTiO, InSnO, ZnSnO, and InZnO.

14. The spike neural network circuit of claim 9, wherein a depth of traps formed in the charge trapping layers of the first neuron synapse bifunctional elements is configured to be deeper than depths of traps formed in the charge trapping layers of the second neuron synapse bifunctional elements and the third neuron synapse bifunctional elements.

15. The spike neural network circuit of claim 12, wherein, based on the intensity of the electric field distributed to the charge supply layer, when the electrons are trapped in the charge trapping layers of the first neuron synapse bifunctional elements, a threshold voltage value increases to perform the depression learning, and
wherein based on the intensity of the electric field distributed to the charge supply layer, when the holes are trapped in the charge trapping layers of the first neuron synapse bifunctional elements, the threshold voltage value decreases to perform the potentiation learning.

16. The spike neural network circuit of claim 9, wherein the channel layer is configured to supply the electrons to the charge trapping layer, and
wherein the charge supply layer is configured to supply the holes to the charge trapping layer.

17. The spike neural network circuit of claim 9, wherein the channel layer is formed of an oxide semiconductor whose conductivity increases in response to light.
